(19) United States
(12) Patent Application Publication
(10) Pub. No.: US 2018/0186618 A1
(43) Pub. Date: Jul. 5, 2018

(54) BEVERAGE DISPENSING ACTIVITIES SYSTEMS AND METHODS

(71) Applicant: kai chow, Happy Valley, OR (US)

(72) Inventor: kai chow, Happy Valley, OR (US)

(21) Appl. No.: 15/395,956

(22) Filed: Dec. 30, 2016

(51) Int. Cl. B67D 1/00; H04L 29/06; B67D 1/08

(52) U.S. Cl. CPC B67D 1/0041; H04W 84/12; B67D 1/0888; H04L 67/42

(57) ABSTRACT

A scalable system that can secure, mount, and store a plurality of beverages of different sizes, shapes, and capacities on mobile racks for performing processor-assisted, ‘hands-free’ ingredient dispensing and other ancillary dispensing activities. The mobile racks can be individually extracted from the system to perform empty beverage replacement. A beverage plug and tap is inserted into an opening of a beverage and the beverage plug compressed to seal the beverage opening. A spout is attached to the tap and fastened. The beverage is mounted onto a cradle in a dispensing position, the spout is inserted into a spout controller, and the mobile rack stowed back to the system with the mounted beverage ready for ingredient dispensing. A client-server applies the methods of a messaging protocol to manage the distributions of messaging protocol packets between connected clients over a wireless network. The messaging protocol packets carry beverage dispensing requirements to the controllers to direct the performances of beverage dispensing activities and, in particular to the spout controllers to direct ingredient dispensing. Abnormal events detected by sensors within the system are distributed by messaging protocol packets to report the abnormal events to clients that have subscribed to the client-server to receive the events.

### FIELD OF THE INVENTION

Embodiments of the claimed invention relate to the application of a client-server to distribute messaging protocol packets between clients over a wireless network to direct processor-assisted performances of beverage dispensing activities and, in particular, the activity of ‘hands-free’ dispensing of ingredients from mounted beverages consolidated within a beverage dispensing activities system.

### BACKGROUND OF THE INVENTION

One of the many memorable times of my life occurred during the 14 months when I was asked to operate an existing Bar and Grill Restaurant in Arizona. I had a simple business plan for the bar: enable my bartenders to perform at their best, provide an excellent drinking experience for the customers, and generate a profit. To that end, I was able to meet many new and delightful people, improve upon my bartending skills, and sell the business. Although the restaurant performed well, I struggled while trying to achieve the full potential from the bar. In retrospect, I realized the error of my ways.

The restaurant had four point-of-sale (POS) systems; each POS prints to a dedicated receipt printer. Two POS were placed together near the front of the restaurant and the other two POS were placed apart at each end of the bar station. When the bartenders complete drink orders for the restaurant POS, the drink orders along with their printed order tickets were placed at the service area of the bar station for pickup. The bartenders were responsible for manually closing-out their drink orders placed from the bar station POS upon completing the drink order. The waiters were responsible for manually closing-out their drink orders placed from the restaurant POS upon serving the drink order. Often, I noticed there were open tickets, duplicate tickets, repeat tickets, comp tickets, credit tickets, cancelled tickets, deleted tickets, voided tickets, drink orders waiting at the service area without their tickets, and drink orders returned with remake tickets for wrong drink orders. Trying to manually reconcile these tickets was time consuming, frustrating, and often ended in futility.

The bartenders were instructed to use jiggers to measure each pour. Often, I noticed that during peak hours the bartenders would put aside the jiggers and revert to ‘free-pouring’. I also noticed that each bartender had their own cocktail recipe and would pour varying liquor amounts when composing the same cocktail. And ‘regular’ customers without a doubt always received ‘a little extra’ in their drinks.

A bin placed under the bar station is where the bartenders were instructed to place emptied and broken liquor bottles. A clipboard placed on the wall across from the bar station is where the bartenders were instructed to log the spilled liquors, returned drink orders, wrong drink orders made, and broken bottles. Often, I noticed during peak hours many required clipboard entries were postponed and later forgotten. When audits were performed, the bottle counts from the bin never agreed with the bottle inventory on the invoices and the entries on the clipboard.

I was the designated bartender whenever a regular bartender was late, sick, or otherwise unable to complete their scheduled shift. The bartenders were always willing to teach me and I gained a different perspective into their daily routines. Often, during peak hours I found myself having to hastily travel back and forth between the bar station and the shelves to retrieve the requested liquors; sometimes resulting in minor cuts and injuries from accidental bumps, jabs, slips, falls, and dropped bottles. Liquor dispensing requires grasping, lifting, inverting, and twisting of bottles of a variety of weight, size, and shape to dispense the liquor. I often found myself nursing my wrists and elbows at the end of the day. Soon, I begin to realize how lifting, inverting, and twisting liquor laden bottles repeatedly throughout a typical work shift can place tremendous strain on the wrists and elbows of the bartenders when continued over a prolonged period of time. Doctors have diagnosed this work related condition as Repetitive Strain Injury (RSI).

### SUMMARY OF THE INVENTION

The inability of my aforementioned attempts to prevent point of sale inefficiencies, track dispensed inventories, establish dispensing consistencies, promote measured dispensing, reduce bar shrinkage, discourage bar theft, establish safe workplace procedures, maintain bar controls, and perform accountable sales, dispensing, and inventory audits gave rise to the embodiments of the claimed invention; wherein mounted beverages that are consolidated within a secured and scalable ingredient dispensing system, managed by Protocol-directed processors, coupled to processor-assisted ingredient dispensing controllers, dispensed ‘hands-free’ when directed by client-server distributed messaging protocol packets over a wireless network, and inventoried by distributed messaging protocol packet logging controllers in real-time could have helped me overcome many of my aforementioned limitations and shortcomings.

One preferred embodiment of the claimed invention is a system designed to secure a plurality of mounted beverages for performing processor-assisted beverage dispensing activities and, in particular, beverage ingredient dispensing. Ledged openings on the system provide access for the placement of individual containers to collect ingredients dispensed from the mounted beverages. Individual racks within the system can be accessed to enable the performance of empty beverage replacement activities. Each ingredient dispensed into the containers is direct, visual, measured, consistent, controlled, logged, original, and ‘hands-free’. The bartenders will no longer have to remember the extensive liquor and volume requirements to dispense cocktail drink orders. Better still, the bartenders will no longer need to search, retrieve, lift, invert, and twist beverages to dispense the ingredient. The removal of these mundane tasks allow the bartenders to focus their full attention to the more gratifying tasks of concocting and mixing exceptional drinks, keeping their bar patrons engaged, and nurturing an excellent experience for the customer.

Another preferred embodiment of the claimed invention is a system for performing ingredient dispensing, consisting of a pourer and a spout controller. The pourer is adapted to attach to an opening of a beverage and then further attached to the spout controller to enable processor-assisted, ‘hands-free’ ingredient dispensing. Unlike the dispensers described in the U.S. Pat. Nos. 5,255,819, 6,036,055, 6,354,468, 8,695,858, 8,783,512, 8,925,769, and 9,004,320, the pourer is void of electronics, is not dependent on batteries for normal operations, is not controlled by a wired user interface, is capable of quick detachment for service, is interchangeable, is not beverage-type dependent, and after servicing can be re-attached to the same or a different beverage-type before attaching to the spout controller to continue the performance of ingredient dispensing. The pourer and the spout controller are fix-mounted behind a faceplate, sheltering them from abnormal user contact and tampering, and from the normal workplace abuses and harsh conditions inherent in a hectic alcohol serving environment.

Yet another preferred embodiment of the claimed invention is the methods of applying a client-server, executing a messaging protocol, to manage the distributions of messaging protocol packets between clients over a wireless network to direct the performances of beverage dispensing activities and, in particular, the activity of processor-assisted ‘hands-free’ ingredient dispensing.

The appliance described in the U.S. Patent Application Number 20,130,085,600 and the robotic system described in U.S. Pat. No. 7,577,498 and U.S. Patent Application Number 20,160,052,770 perform automated cocktail dispensing. When a user selects a Long Island Ice Tea on the user interface of the appliance and robotic systems, it will automatically dispense and mix the same Long Island Iced Tea, consistently upon every selection. However, a bartender given the same liquor ingredients can compose a Long Island Iced Tea at least a thousand different ways for the customer to enjoy and experience. Bartending is among one of the oldest professions in the world and it is my hope that technology would enhance rather than replace the time honored skills of the bartender.

Therefore, the preferred embodiments of this claimed invention endeavors to consolidate the many beverage dispensing activities performed in alcohol serving establishments into a secured, scalable, managed, controlled, and distributed systems and methods to: enable the bartenders to perform at their best and produce an excellent drinking experience for the customers, and empower the operators to achieve the full potential from their alcohol serving business.

### BRIEF DESCRIPTION OF THE DRAWINGS

FIG. 1A diagrammatically illustrates an example consolidated beverage dispensing activities system with multiple racks.

FIG. 1B diagrammatically illustrates the views of an example consolidated beverage dispensing activities system with a single rack and with the rack extracted from the system.

FIG. 1C diagrammatically illustrates the views of an example beverage mounting apparatus for the shelf showing a bracket, rail, and cradle assembly.

FIG. 1D diagrammatically illustrates the views of an example spout controller showing silhouettes of the embedded components.

FIG. 1E diagrammatically illustrates the views of an example ledge.

FIG. 2A diagrammatically illustrates an example spout of the pourer.

FIG. 2B continues to diagrammatically illustrates the views of the spout in FIG. 2A.

FIG. 2C diagrammatically illustrates an example tap and beverage plug of the pourer.

FIG. 2D diagrammatically illustrates the cross section view of the spout in FIG. 2B.

FIG. 3A diagrammatically illustrates an example client-server network and the connected clients.

FIG. 3B diagrammatically illustrates the electrically connected components of an example messaging controller.

FIG. 3C diagrammatically illustrates the electrically connected components of an example rack controller.

FIG. 3D diagrammatically illustrates the electrically connected components of an example spout controller.

FIG. 4A illustrates four phases of an example beverage dispensing activity requirement directed to spout controller(s) to ‘pour’ ingredients for a cocktail.

FIG. 4B illustrates four phases of an example beverage dispensing activity requirement directed to controller(s) to perform a ‘self-test’.

FIG. 4C illustrates four phases of an example beverage dispensing activity requirement directed to spout controller(s) to ‘cancel’ a ‘pour’ requirement in the midst of performance.

FIG. 4D illustrates four phases of an example beverage dispensing activity requirement directed to a rack controller to release a rack and spout controller to ‘replace’ an empty beverage.

### DETAILED DESCRIPTION OF THE PREFERRED EMBODIMENTS

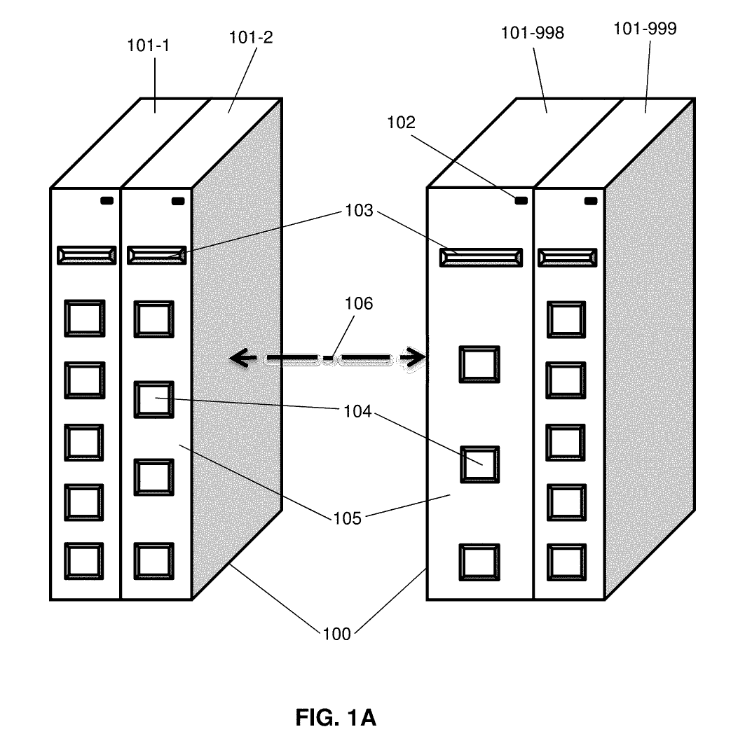

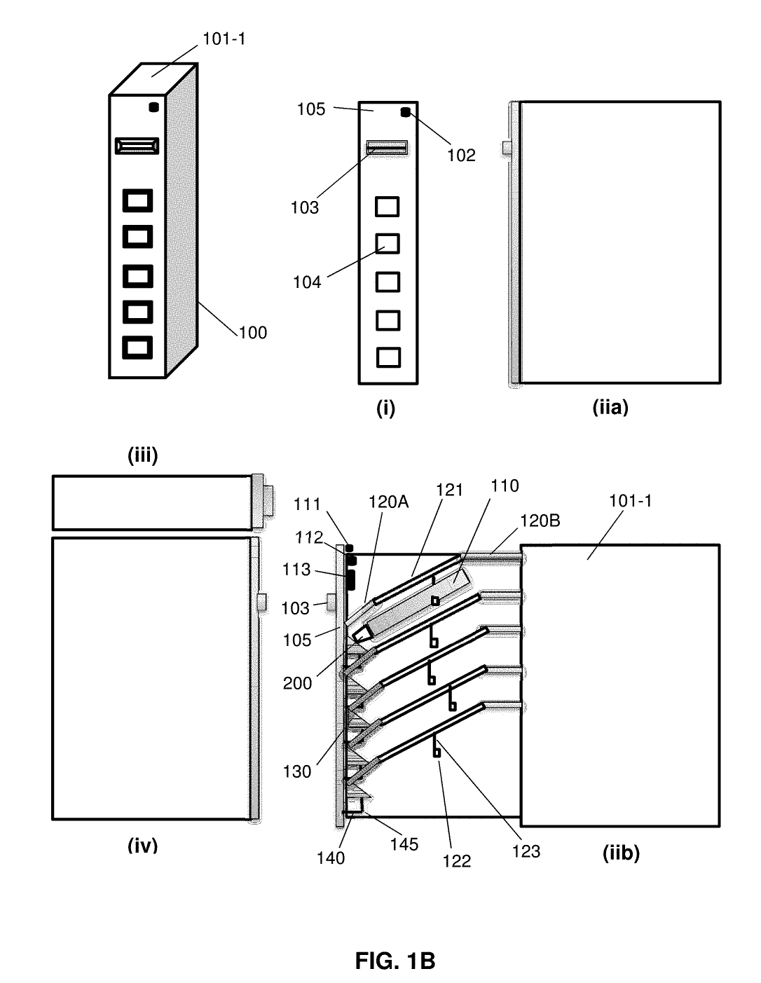

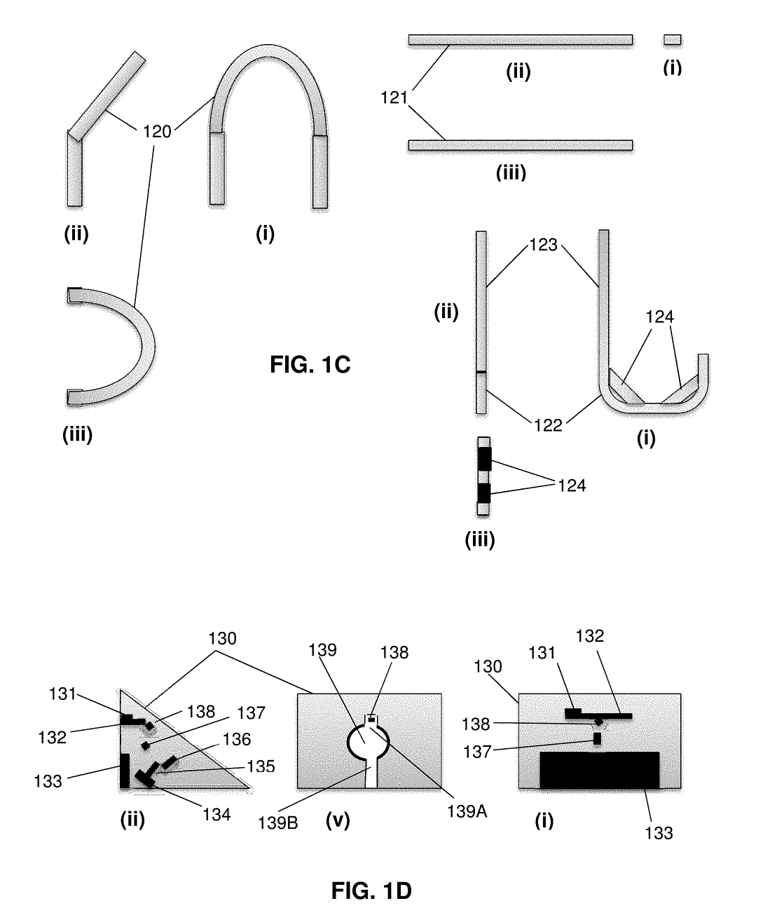

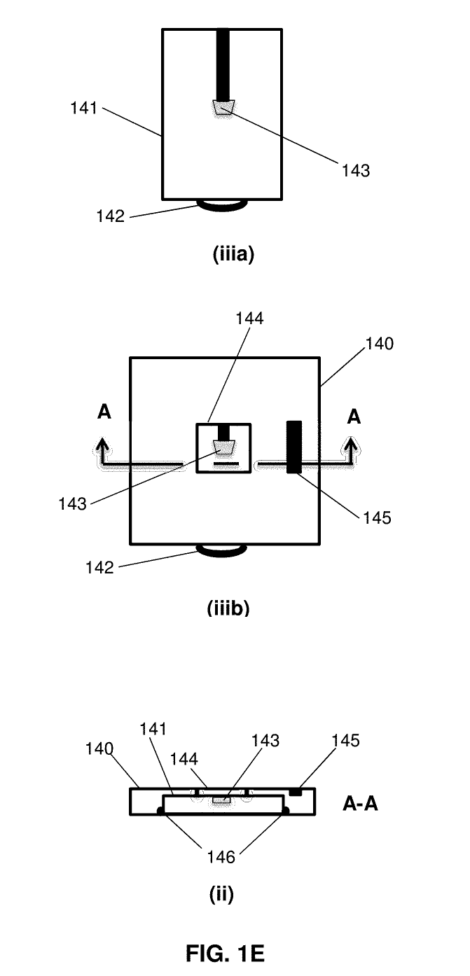

FIG. 1A shows a beverage dispensing activities system 100 with multiple racks 101 secured to a mobile rack platform. Each rack (101-1, 101-2 . . . 101-999) on the mobile rack platform is individually releasable for extraction from the system. Extracted racks can be inserted back into the system and re-secured. The system can be configured to house a single rack with the rack mounting one or more beverages FIG. 1B. The system can also be configured to house multiple racks with each rack mounting one or more, and same or varying number of beverages FIG. 1A. The system 100 can be placed on surfaces, mounted against walls, and attached to other structures. The system 100 can also assume different shapes, sizes, forms, and configurations; provided that the operational and functional requirements of performing beverage dispensing activities and, in particular, the activity of ingredient dispensing is not hindered or compromised. The beverage dispensing capacity of the system 100 can be expanded by subscribing the controllers of the additional system or systems as clients to the client-server. The operation and function of the expanded system 100 is unaffected whether the additional system or systems are physically attached together or placed apart 106.

FIG. 1B shows the front (i), right (iia), left-top (iii), and left (iv) views of a single rack system 101-1. Also shown is the right (iib) view of the rack 101-1 extracted from the system 101. A faceplate 105 is affixed to each rack 101-1, covering the opening of the system 100. A spout controller 130 is mounted to the faceplate 105 above each ledged opening 104, designed to encapsulate the spout of the pourer 200. When a container is properly placed on the ledge 140 directly under the nozzle of the spout, an object detection sensor 145 will detect the presence of the container and notify the spout controller 130 to begin ingredient dispensing. The object detection sensor 145 continues container monitoring until the performance of ingredient dispensing is completed with a successful, partial, or failed result; or terminated with a ‘cancel’ requirement. If the object detection sensor 145 detects the removal of the container at any time during ingredient dispensing, the object detection sensor 145 will immediately notify the spout controller 130 to stop the dispensing. The remainder of the ingredient dispensing will resume when the container is properly placed back on the ledge, terminated by a timeout expired event, or cancelled by a ‘cancel’ requirement.

The rack 101-1 is an interconnection of frameworks linked to the mobile rack platform on all sides; top to bottom, front to back, and left to right. The mobile rack platform provides independent movement for the rack 101-1 during extraction from and insertion into the system 100. The rail 121 is anchored between a front rack bracket 120A and a companion rear rack bracket 120B to provide the anchor for the cradle linkage 123, the adjustable shelving for the cradle 122, and the fittings to mount and support the beverage 110.

To replace a mounted beverage 110 emptied during ingredient dispensing: the spout controller 130 for the empty beverage 110 receives a messaging protocol packet containing the ‘replace’ requirement; the rack controller 113 for the rack 101-1 mounting the empty beverage 110 receives a messaging protocol packet containing the ‘release’ requirement; the locking mechanism 112 releases the rack 101-1 for extraction from the system 100, assisted by a handhold 103; the rack controller 113 receives a rack ‘open’ notification from a lock sensor 111 and initiates a messaging protocol packet containing the successful rack ‘open’ event to the subscribers of the event; the empty beverage 110 is dismounted from the cradle 122; the spout controller 130 receives notification from the switch sensor that the spout is removed from the cored opening; the beverage plug of the pourer 200 is detached from the opening of the empty beverage 110, properly serviced, and reattached to the opening of the replacement beverage 110; the replacement beverage 110 is mounted onto the cradle 122 and properly adjusted; the spout controller 130 receives notification from the switch sensor once the spout is properly inserted into the cored opening, composes a successful result of the insertion, updates the result to the ‘replace’ requirement, bundles the updated requirement into a messaging protocol packet, and initiates the messaging protocol packet to the subscribers of the result; the rack 101-1 is inserted back into the system 100; the locking mechanism 112 is activated to secure the rack 101-1; and the rack controller 113 receives notification from the lock sensor 111 confirming the rack 101-1 is properly stowed, composes a successful ‘closure’ event, updates the event to the ‘release’ requirement, bundles the updated requirement into a messaging protocol packet, and initiates the messaging protocol packet to the subscribers of the event.

The rack 101-1 is secured to the system 100 by a locking mechanism 112 that is releasable when the rack controller 113 receives a messaging protocol packet containing the ‘release’ requirement, directing it to energize power to the locking mechanism 112 to release the rack 101-1. The locking mechanism 112 can also be released directly by a USB connection 102 from a client initiating a ‘release’ messaging protocol packet. A lock sensor 111 monitors for all occurrences of rack openings and closures. When the lock sensor 111 detects an abnormal rack opening or closure event not associated with a requirement; the rack controller 113 will receive a notification from the lock sensor 111, compose an abnormal ‘open’ or ‘closure’ event, bundle the event into a messaging protocol packet, and initiate the messaging protocol packet to clients that have subscribed to receive either one of the events.

The Protocol defines encodings of beverage dispensing activity requirements, events, and results that are discretely bundled into messaging protocol packets in accordance with the methods of a messaging protocol and distributed by a client-server over a wireless network to subscribing clients of the beverage dispensing activities. Each activity is defined by a plurality of variable-length character string parameters that are partitioned by a hierarchical set of delimiters. Each requirement contains the encoded syntax configured parameters of alpha-numeric and special characters necessary to direct the processors, programmatically configured to recognize the requirements, to perform the beverage dispensing activities.

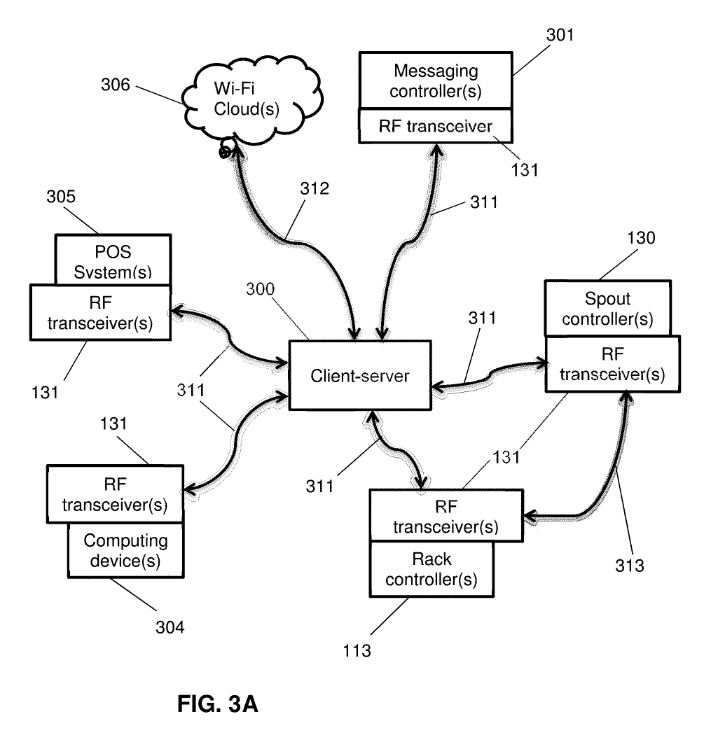

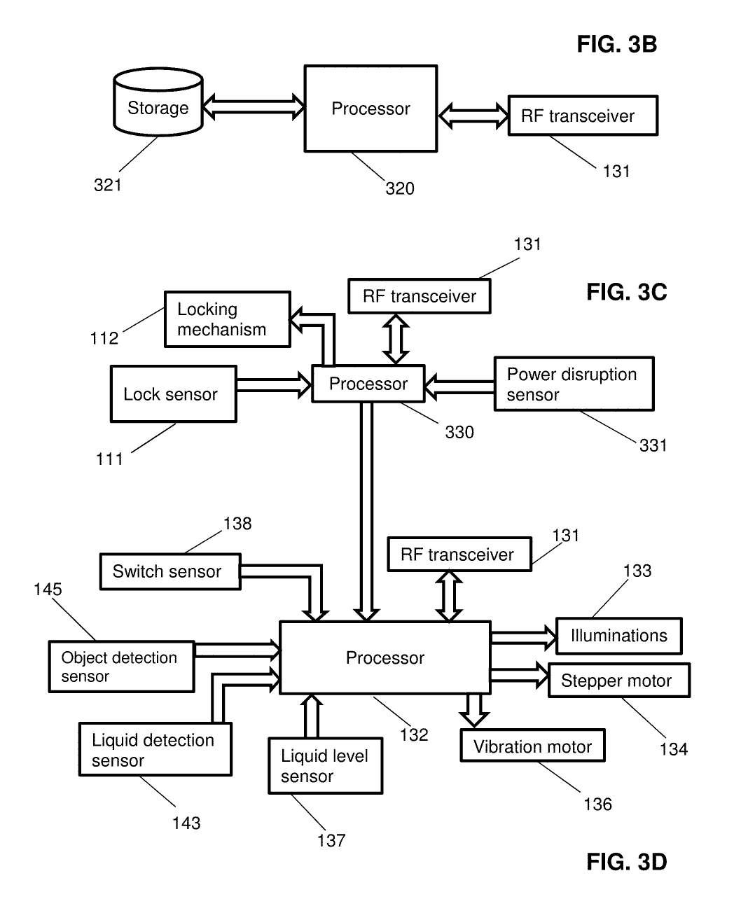

Messaging protocol packets are initiated by subscribing clients and distributed by the client-server 300 over a wireless network to other clients that have subscribed to receive the specific beverage dispensing activities FIG. 3A. Subscribing clients are given the authority to initiate activities, request to receive activities, or both. The clients can be any point of sale system(s) 305, computing device(s) 304, Wi-Fi cloud(s) 306, messaging controller(s) 301, rack controller(s) 113, and spout controller(s) 130. The client-server is responsible for applying the methods of a messaging protocol to manage, identify, authenticate, and authorize the messaging services of subscribing clients.

Examples of beverage dispensing activities are: ‘ready’ event from functioning controllers after power up or a ‘ready’ requirement to confirm the ready state of the controllers; ‘release’ requirements to release racks for routine maintenance or beverage replacement; ‘replace’ requirements to prepare spout controllers for empty beverage replacement; ‘cancel’ requirements to cancel beverage dispensing activities in various stages of performance; ‘pour’ requirements to direct spout controllers to perform ingredient dispensing; ‘self-test’ requirements to direct controllers to perform self-test; rack management activity requirements to direct rack controllers to perform ‘power down’, ‘standby’, ‘exit standby’, and other functions; beverage management activity requirements to define cocktail recipes, dispensing limits, dispensing overrides, beverage types, beverage volumes, illumination colors, and other functions; inventory management activity requirements to set, add to, subtract from, remove, clear, and verify beverage volumes, and other functions; abnormal restart, beverage tampering, beverage leakage, empty beverage, rack open, rack closure, timeout expired, power outage, and other activity events; audit management activity requirements to initiate an activity audit, a dispensing data audit, an inventory data audit, an events audit, and other user definable audits; and so forth.

FIG. 1C shows the front (i), right (ii), and right-top (iii) views of the rack bracket 120, rail 121, and cradle assembly consisting of the cradle 122 and cradle linkage 123. The rail 121 is anchored between the front rack bracket 120A and the companion rear rack bracket 120B. The rail 121 and the cradle linkage 123 can be anchored at any point along the length of the rail 121 and the cradle linkage 123, to allow for horizontal, vertical, and lateral adjustments of the cradle 122 to properly position the beverage 110 and align the spout for insertion. Fittings 124 can be applied to the cradle 122 to accommodate and support mounted beverages 110 of same or assorted proportions, dimensions, ingredients, and ingredient capacities.

FIG. 1D shows the front (i) and right (ii) translucent views of the spout controller 130 outlining the silhouettes of the RF transceiver 131, processor 132, illuminations 133, stepper motor 134, gear shaft 135, vibration motor 136, liquid level sensor 137, and switch sensor 138. The back (v) view of the spout controller 130 shows a cored opening 139, top channel 139A, and bottom channel 139B. The bottom channel 139B applies the nozzle to guide and align the insertion of the spout, while the wedge settles and secures to the top channel 139A once the spout is fully inserted into the cored opening 139. The wedge makes contact with the switch sensor 138 and triggers a notification to the spout controller 130. The switch sensor 138 will also notify the spout controller 130 whenever the wedge is unsettled from the top channel 139A. Normal events detected by the spout controller sensors are acknowledged and processed accordingly. Abnormal events detected by the spout controller sensors are recorded and initiated to the subscribers of these events. The processor 132 is configured to programmatically execute the requirements of beverage dispensing activities to direct the performances of the connected motors and manage the handling of interrupts from the connected sensors.

Once the spout is inserted into the cored opening 139 of the spout controller 130; the beverage 110 is immobilized to the cradle 122, the shaft chamber of the spout is aligned and linked with the gear shaft 135 of the stepper motor 134, the vibration motor 136 will be positioned against the spout near the side of the inner chamber, illuminations 133 will be visible through the faceplate 105 near the ledged openings 104 to provide visual identification to coordinate ingredient dispensing, and the liquid level sensor 137 will be positioned above the liquid level indicator port-hole to establish an optical connection with the liquid level indicator.

FIG. 1E shows the right-top (iiia) view of a spillage tray 141 with a liquid detection sensor 143, the right-top (iiib) view of the liquid detection sensor 143 positioned under the cutout 144 of the ledge 140, and the right (ii) view of the cross section A-A of the ledge 140 and the spillage tray 141. A handhold 142 is attached to the spillage tray 141 to assist with the extraction of the spillage tray to remove the spilled ingredients. A mounted beverage leakage detection scenario: the leaked ingredient from the mounted beverage 110 follows the path of least resistance within the pourer 200 and drips off the nozzle; falls onto the liquid detection sensor 143; and the spout controller 130 receives notification from the liquid detection sensor 143, composes a ‘leakage’ event, bundles the event into a messaging protocol packet, and initiates the messaging protocol packet to the subscribers of this event.

The cutout 144 allows spilled ingredient from the container to drain through the sides of the cutout 144, onto the spillage tray 141, and avoid triggering the liquid detection sensor 143. Tracks 146 along the bottom, guide the proper placement and removal of the spillage tray 141. The object detection sensor 145 is positioned on the ledge 140, calibrated to detect the presence of a properly placed container on the ledge 140 and the removal of the properly placed container.

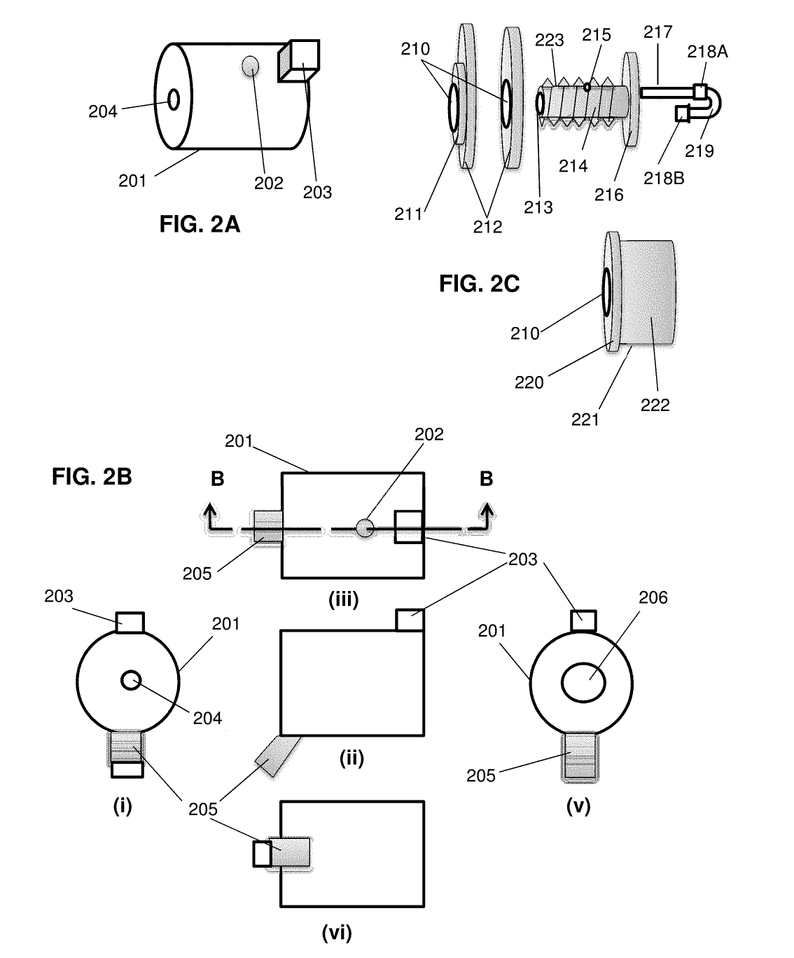

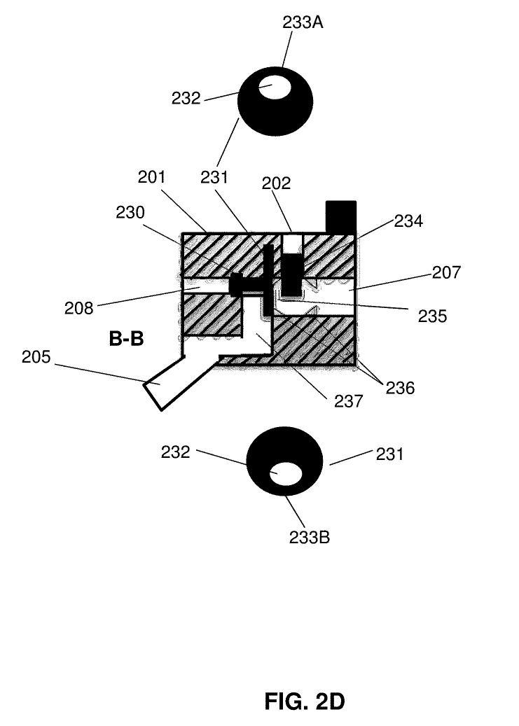

FIG. 2A and FIG. 2C shows the pourer comprising a spout 201, a tap 223, and a beverage plug 221. FIG. 2B shows the front (i) view, right-top (iii) view, right (ii) view, back (v) view, and right-bottom (vi) view of the spout 201 with a shaft opening 204, a stem opening 206, a wedge 203, a liquid level indicator port-hole 202, and a nozzle 205. The nozzle 205 serves the dual purpose of maintaining proper alignment against the bottom channel 139B during the insertion of the spout 201 into the cored opening 139 of the spout controller 130 and funneling the dispensed ingredient into a properly placed container. The wedge 203 immobilizes the spout 201 against the top channel 139A, once the spout 201 is properly inserted into the cored opening 139. The stem opening 206 will accommodate the attachment of the tap 223. The shaft opening 204 will accommodate the attachment of the gear shaft 135.

The tap 223 comprises a threaded stem 214 with a base 216, a breather air tube 217 with a first check valve 218A, a second check valve 218B, a bent end piece 219, lock nuts 212, and a washer 211. The beverage plug 221 comprises a flange 220 and a compressible stopper 222 with a hollow cylindrical core 210 to accommodate the insertion of the threaded stem 214. The lock nuts 212 and washer 211 share a similar diameter opening 210. The threaded stem 214 and base 216 has a hollow cylindrical core 213 to facilitate the flow of mounted beverage ingredient to the spout 201 through the beverage plug 221. The front section of the breather air tube 217 is attached to the inner wall of the threaded stem 214 with the breather hole 215 from the front section of the breather air tube 217 exiting through the exterior of the thread stem 214 while the tail section of the breather air tube 217 extends out through the base 216. The first check valve 218A is attached to the tail section of the breather air tube 217, followed by the bent end piece 219, and the second check valve 218B.

The second check valve 218B prevents beverage ingredient from entering the bent end piece 219 when the tap 223 and beverage plug 221 is attached to the opening of a beverage. The breather air tube 217 with the two check valves (218A, 218B) and the bent end piece 219 will allow exterior air to enter through the breather hole 215 and into the mounted beverage to equalize the pressure within the beverage during ingredient dispensing. The first check valve 218A and the bent end piece 219 will prevent beverage ingredient from entering the breather air tube 217 during inactive periods when the beverage 110 remains mounted in a dispensing position.

To assemble the tap 223 and the beverage plug 221 to the opening of a beverage; insert the threaded stem 214 and base 216 from the bottom end of the compressible stopper 222 through the hollow cylindrical core 210 until the base 216 is flushed against the bottom end of the stopper 222 and secured by a lock nut 212 onto the threaded stem 214, insert the beverage plug 221 into an opening of a beverage until the flange 220 is flushed against the beverage opening, and tighten the lock nut 212 on the threaded stem 314 against the flange 220 to compress the stopper 222 from the bottom. After completing the compression, the sides of the stopper 222 will expand against the interior wall of the beverage opening to create a tight and leak-proof adhesion. The breather hole 215 is positioned unobstructed after the tightening.

To begin beverage replacement, the lock nut 212 against the flange 220 must be loosened to de-compress the stopper 222 before attempting to retract the beverage plug 221 from the beverage opening. The application of the tap 223 with the beverage plug 221 facilitates for quick, easy, and simple removal during beverage replacement and servicing before reattaching to the opening of another beverage without the need to disassemble the tap 223 from the spout 201. The beverage plug 221 can be adapted to fit beverage openings of assorted sizes.

To assemble the spout 201 to the tap 223; thread another lock nut 212 onto the threaded stem 214, followed with a washer 211, then insert the threaded stem 214 into the stem opening 206 of the spout 201 and tighten against the threaded stem chamber 207, and tighten the lock nut 212 and washer 211 against the threaded opening 206 of the spout 201 to complete the assembly of the pourer.

To ready the beverage for dispensing; place the beverage 110 on the cradle 122 to initiate the distribution of beverage ingredient into the threaded stem chamber 207 to equalize the pressure within the pourer and activate the liquid level indicator 234, align the spout 201 with the cored opening 139 of the spout controller 130 by applying adjustments on the cradle linkage 123, apply fittings 124 to further adjust the alignment, lower the spout 201 into the cored opening 139 of the spout controller 130 until the wedge 203 is settled and secured to the top channel 139A, check illuminations 133 to confirm insertion was successfully performed, and insert the rack 101-1 back into the system 100.

FIG. 2D shows the cross section B-B view of the spout of FIG. 2B (iii). Also shown are the back views of the cylindrical disk 231 rotated to the closed position 233A and to the open position 233B. When the spout 201 is inserted into the cored opening 139 of the spout controller 130, the gear shaft 135 of the stepper motor 134 is fitted into the shaft opening 204, aligned with the shaft chamber 208, and attached to the base of the shaft joint 230. The shaft joint 230 is mounted on-center to the cylindrical disk 231, enabling the shaft joint 230 and cylindrical disk 231 to move in unison with the gear shaft 135 when rotated by the stepper motor 134. The cylindrical disk 231 is pressed against the O-ring 236 affixed stem chamber opening 235 above the inner chamber 237 by the base of the shaft joint 230.

When a controlled rotational force from the stepper motor's gear shaft 135 is applied to the shaft joint 230, the diameter opening 232 on the cylindrical disk 231 will begin to rotate to align with the stem chamber opening 235. When the cylindrical disk 231 is rotated to the open position 233B, the ingredient is allowed to flow from the mounted beverage 110, through the beverage plug 221 and tap 223, into the threaded stem chamber 207, through the stem chamber opening 235 and the opening 232 on the cylindrical disk 231, into the inner chamber 237, through the nozzle 205, and into a properly placed container. When the diameter opening 232 on the cylindrical disk 231 is rotated to the closed position 233A, the opening 232 on the cylindrical disk 231 is rotated away from the O-ring 236 affixed stem chamber opening 235 and ending the flow of the ingredient. The cylindrical disk 231 can be rotated clockwise or counter-clockwise.

Open position 233B for the cylindrical disk 231 is the moment when beverage ingredient begins flowing between the cylindrical disk opening 232 and the stem chamber opening 235. When the center axis of the cylindrical disk opening 232 and the stem chamber opening 235 are in direct alignment, the flow rate of the ingredient is at the highest. Closed position 233A is the moment the ingredient is no longer flowing between the cylindrical disk opening 232 and the stem chamber opening 235.

A liquid level indicator 234 placed near the stem chamber opening 235 is optically connected to a liquid level sensor 137 through the liquid level indicator port-hole 202 on the surface of the spout 201. When the beverage is emptied during ingredient dispensing; the liquid level indicator 234 optically triggers an ‘empty’ beverage event to the liquid level sensor 137, the liquid level sensor 137 notifies the spout controller 130, and the spout controller 130 determines the validity of the ‘empty’ event against stored beverage volume data, composes an ‘empty’ event updated with the volume status, bundles the updated event into a messaging protocol packet, and initiates the messaging protocol packet to the subscribers of this event.

Subscribers of the ‘empty’ event can initiate a ‘release’ and ‘replace’ requirement messaging protocol packet to perform empty beverage replacement and either enable the spout controller to complete the remainder ingredient dispensing or terminate the remainder ingredient dispensing with a ‘cancel’ requirement, or redirect the remainder of the ingredient dispensing with an ‘pour’ requirement messaging protocol packet issued to another spout controller with the similar type beverage.

FIG. 3A shows a messaging protocol enabled client-server distributing messaging protocol packets between clients enabled by RF transceivers 131 over a wireless network. The Wi-Fi cloud(s) 306, point of sale system(s) 305, computing device(s) 304, rack controller(s) 113, spout controller(s) 130, and messaging controller(s) 301 are the clients. The client-server 300 is configured to maintain a dependable connection 311 with the RF transceiver enabled and Wi-Fi connected 312 clients, and manage the distributions (311, 312) of messaging protocol packets between the clients. Each rack controller 113 within the system can also be configured to initiate wireless communications 313 with the spout controllers 130 within the same rack to distribute the requirements from the communicated messaging protocol packets.

FIG. 3B shows the main modules of the messaging controller 301 comprising a processor 320, RF transceiver 131 and storage medium 321. When the processor 320 receives a messaging protocol packet; the properly composed encoded requirements are extracted, the availability of existing resources to perform the requirements are determined, the requirements are updated to the inventory database 321, the clients in ‘ready’ state necessary to perform the requirements are confirmed, the requirement and the intended controller is bundled into a messaging protocol packet, and the messaging protocol packet is initiated to the client-server for distribution to the intended controller and clients that have subscribed to receive the requirement. When the processor 320 receives a messaging protocol packet with raw requirements; a user configured beverage dispensing activities keyword filter is applied to unbundle the raw requirements into their discrete and properly composed encoded requirements before proceeding to ready each requirement for processing and initiation to subscribing clients.

The processor 320 will coordinate messaging protocol packet distributions to avoid activity conflicts among the receiving controllers, manage the distributions to ensure beverage dispensing activity resources are allocated efficiently, monitor the resources and maintain resource compliance between competing requirements, re-bundle the returned messaging protocol packets with results from the processing for initiation to clients that have subscribed to receive the results, update the database to maintain accuracy, and make available the beverage dispensing activity resources for another messaging protocol packet requirement.

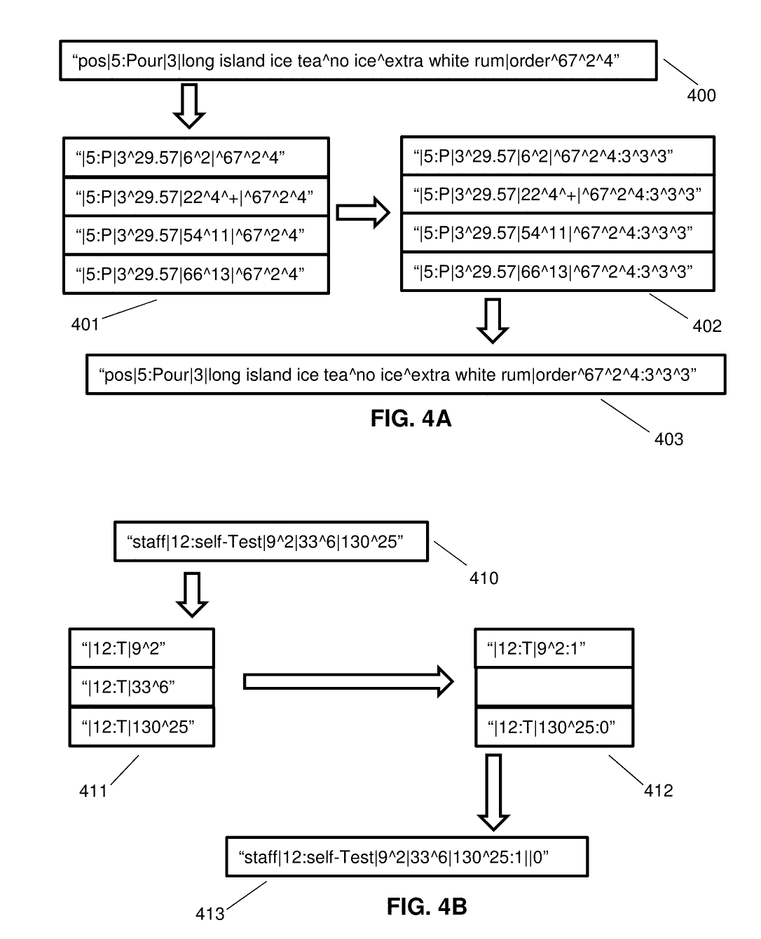

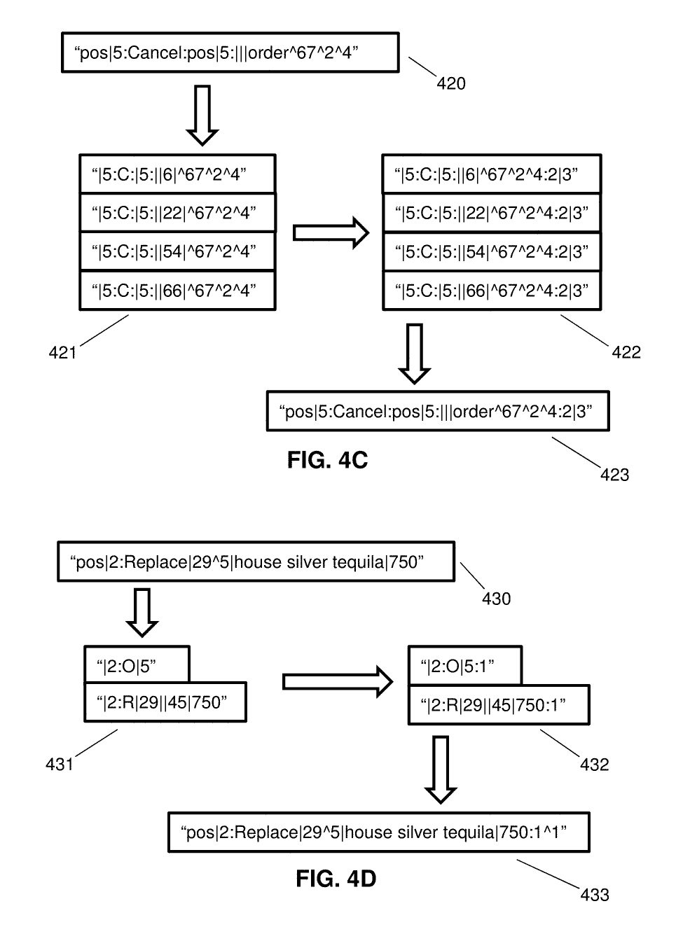

A raw requirement example FIG. 4A: A second of four drink orders initiated from POS #5 to ‘pour’ ingredients for three Long Island Ice Tea cocktails with special requests 400. After filtering, four discrete encoded requirements are properly composed 401 and bundled into their respective messaging protocol packets for initiation to the spout controllers and subscribing clients. Each encoded requirement is directed to the mounted beverages (6, 22, 54, 66) of type (Tequila, White Rum, Gin, Vodka) in respective racks (2, 4, 11, 13) required to blend a Long Island Ice Tea along with the ingredient amount (29.57 mL) to dispense. The (+) directs the spout controller to add ‘a little extra’ to the amount dispensed. After dispensing activity performance processing, the four returned messaging protocol packets containing the requirement updated with the results 402 are repackaged back into the raw requirement 403 for initiation to subscribing clients of the results. The results indicated successful completion (3) of all three pours by the four spout controllers. A (0) will indicate a failed performance. A number other than (3) will indicate partial completion of the performance.

Another raw requirement example FIG. 4B: An activity initiated from computing device #12 to perform ‘self-test’ of spout controllers (9, 33, 130) in respective racks (2, 6, 25) 410. The filter is applied to properly compose three discrete requirements 411 for initiation to the spout controllers and subscribing clients. The two returned messaging protocol packets containing the requirement updated with the results 412 are repackaged back into the raw requirement 413 for initiation to subscribing clients of the results. The first requirement returned with successful ‘self-test’ status (1). The second requirement did not return due to transmission problem. The third requirement returned with failed ‘self-test’ status (0).

Yet another raw requirement example FIG. 4C: An activity initiated from POS #5 to ‘cancel’ the active dispensing activity performances of FIG. 4A 420. The filter is applied to properly compose four discrete requirements 421 for initiation to the spout controllers and subscribing clients. The returned messaging protocol packets containing the requirement updated with the results 422 are repackaged back into the raw requirement 423 for initiation to subscribing clients of the results. The results indicate two of three pours was cancelled.

Still yet another raw requirement example FIG. 4D: An activity initiated from POS #2 to ‘replace’ an empty beverage at spout controller (29) in rack (5) with house silver tequila (45) having 750 mL 430. The filter is applied to properly compose the three discrete requirements 431 for initiation to the spout controllers and subscribing clients. The returned messaging protocol packets containing the requirement updated with the results 432 are repackaged back into the raw requirement 433. The results indicate successful rack open (1) and beverage replacement (1) performances.

When the dispensing capacity of the system is expanded, the operation and function of the existing messaging controller can be distributed and allocated to another messaging controller. The client-server is updated with the new client subscriptions from the additional system. The client-server is further updated with the subscriptions of the additional messaging controller. The ability of the client-server to add clients, delete clients, and change the client's subscription in real-time allows for an open platform for the other clients to process the subscribed messaging protocol packets and perform customized outputs. Display clients can generate specific outputs from the subscribed messaging protocol packets independent of the system. Print clients can generate specific outputs from the subscribed messaging protocol packets independent of the system Report clients can generate specific outputs from the subscribed messaging protocol packets independent of the system. Audio clients can generate specific outputs from the subscribed messaging protocol packets independent of the system. Processing clients can perform specific filtering and initiate messaging protocol packet distributions independent of the system. And database clients can maintain specific inputs from the subscribed messaging protocol packets independent of the system.

FIG. 3C shows the main modules of the rack controller comprising a processor 330, a RF transceiver 131, a locking mechanism 112, a lock sensor 111, and a power disruption sensor 331. Whenever the rack is extracted from or inserted to the system, the lock sensor 111 triggers an interrupt to notify the processor 330. If the processor 330 determines the cause of the interrupt is abnormal, the processor 330 composes an abnormal rack ‘open’ or ‘closure’ event, bundles the event into a messaging protocol packet, and initiates the messaging protocol packet to the subscribers of either one of the events. Whenever the rack controller experiences loss of main power and switches to emergency backup power, the power disruption sensor 331 detects the loss of main power and triggers an interrupt to notify the processor 330. The processor 330 will complete the remainder of the current beverage dispensing activity performance, compose a ‘power disruption’ event, bundle the requirement event into a messaging protocol packet, and initiate the messaging protocol packet to the subscribers of the event.

When the processor 330 receives the messaging protocol packet; the processor 330 extracts the requirement, verifies each parameters in the requirement, updates the parameters to internal storage, and begin beverage dispensing activity processing. If the parameters direct the processor 330 to ‘release’ the rack, the locking mechanism is energized. The lock sensor triggers an interrupt to the processor 330 to indicate a rack ‘open’ event. A successful rack open result is bundled into a messaging protocol packet and initiated to subscribers of the event.

The rack controller is electrically tethered to each spout controllers within the rack to enable coordinated communications and distributions of activity requirements. This tethered configuration permits the spout controllers to either continue as subscribers to the client-server or delist their subscriptions and allow the rack controller to assume the subscriptions of the spout controllers.

FIG. 3D shows the main modules of the spout controller comprising a processor 132, a RF transceiver 131, illuminations 133, a stepper motor 134, a vibration motor 136, a liquid level sensor 137, a liquid detection sensor 143, an object detection sensor 145, and a switch sensor 138. When the processor 132 receives the messaging protocol packet; the processor 132 extracts the requirement, verifies each parameters in the requirement, updates the parameters to internal storage, and activates the appropriate illuminations 133 to begin the coordination of ingredient dispensing activity processing. If the parameters direct the processor 132 to perform the ‘pour’ activity, the processor 132 programmatically activates the object detection sensor 145 to begin monitoring the ledge for a container; calculates the time interval necessary for the stepper motor 134 to control the rotations of the cylindrical disk 231 between closed 233A, open 233B, and closed 233A position to dispense the required amounts of ingredient; receives an interrupt from the object detection sensor 145 when a container is properly placed on the ledge; energizes the stepper motor 134 to begin the controlled rotation of the gear shaft to rotate the spout's cylindrical disk into the open 233A position to begin ‘hands-free’ ingredient dispensing; and activates the vibration motor 136 for a brief moment, after the opening on the cylindrical disk has rotated to the closed 233B position to generate the requisite agitation to dislodge any remaining ingredient still clinging to the inner chamber and the nozzle to fall into the container.

If during ingredient dispensing the liquid level indicator 234 triggers an empty beverage condition to the liquid level sensor 137; the processor 132 receives an interrupt from the liquid level sensor 137, stops ingredient dispensing, composes an ‘empty’ event updated with the remainder dispensing data, bundles the updated event into a messaging protocol packet, and initiates the messaging protocol packet to the subscribers of the event. The remainder ingredient dispensing can resume from the same spout controller after empty beverage replacement when a ‘release’ requirement messaging protocol packet is initiated to direct the rack controller to release the rack and a ‘replace’ requirement messaging protocol packet is initiated to the spout controller to prepare for empty beverage replacement. The remainder ingredient dispensing can be redirected to another spout controller having the same beverage type to complete the dispensing with a ‘pour’ requirement messaging protocol packet. The remainder ingredient dispensing can also be cancelled by a ‘cancel’ requirement messaging protocol packet.

If the beverage dispensing activity directs the processor 132 to perform an empty beverage replacement after the rack is released and extracted from the system: the empty beverage 110 is removed from the cradle 122; the pourer 200 is detached and serviced; the pourer 200 is re-attached to the replacement beverage 110; the replacement beverage is placed on the cradle 122 and inserted into the spout controller 130; the switch sensor 138 triggers an interrupt to the processor 132 when the spout 201 is properly settled and secured to the spout controller 130; the rack 101-1 is inserted to the system and confirmed when the lock sensor 111 triggers an interrupt to notify the processor 330; the processor 330 composes the results from the rack closure, updates the results to the ‘release’ requirement, bundles the updated requirement into a messaging protocol packet, and initiates the messaging protocol packet to the messaging controller and the subscribers of the results; and the processor 132 retrieves the stored remainder dispensing information, verifies with the object detection sensor 145 that the container is properly placed, proceeds to complete the remainder dispensing, composes the results from the performance, updates the results into the ‘replace’ requirement, bundles the updated requirement into a messaging protocol packet, and initiates the messaging protocol packet to the messaging controller and the subscribers of the results.

At any time during empty beverage replacement, abnormal beverage tampering attempted on the exposed beverages mounted on the extracted rack will trigger the switch sensor 138 to initiate an interrupt to notify the processor 132. The processor 132 will then compose a result from the abnormal event, bundle the event into a messaging protocol packet, and initiate the messaging protocol packet to the subscribers of the event.

What is claimed is:

1. A beverage dispensing activities system, comprising:
a housing to secure a mobile rack platform for mounting a plurality of beverages readied to perform processor-assisted beverage dispensing activities,
wherein the mobile rack platform can be released for extraction from the housing to access the mounted beverages emptied during processor-assisted ingredient dispensing;
wherein the mobile rack platform can be stowed back to the housing and secured after performing empty beverage fulfillment;
a Protocol to define a plurality of parameters to direct the performances of processor-assisted beverage dispensing activities; and
a server network to apply the methods of a messaging protocol to wirelessly distribute the parameters bundled within messaging protocol packets.

2. An ingredient dispensing system, comprising:
a spout controller to perform Protocol-directed, processor-assisted ingredient dispensing; and
a pourer to couple to an opening of a beverage and then couple to the spout controller to establish a conduit for the passage of ingredient from the beverage.

3. The beverage dispensing activities system of claim 1, wherein one embodiment of the mobile rack platform comprises a single rack to be extractable from the housing when released by at least one of remote or direct means.

4. The beverage dispensing activities system of claim 1, wherein another embodiment of the mobile rack platform comprises a plurality of racks to be independently extractable from the housing when each rack is independently released by at least one of remote or direct means.

5. The beverage dispensing activities system of claims 3 and 4, wherein the rack comprises:
a faceplate, coupled to the rack and comprising:
a plurality of dispensing-openings along the surface, wherein above each dispensing-opening is readied to mount a spout controller, and
a handhold to assist with the extraction and insertion of the rack;
a plurality of shelves, wherein each shelf comprising:
a cradle to mount beverages of diverse dimensions, varied proportions, disparate capacities, and assorted ingredients; and
an assembly of brackets, rail, and linkages coupled to the rack to anchor the cradle and to enable horizontal, vertical, and lateral mounting adjustments, wherein the cradle will be positioned above each dispensing-opening.
a plurality of ledges, wherein each ledge is coupled to the bottom of a dispensing-opening, comprising:
an object detection sensor, coupled to the ledge and electrically coupled to the spout controller to enable interrupt handling upon each occurrence when a container is either placed on or removed off the ledge,
a cutout, positioned on the ledge and below the spout controller to enable ingredient leakage detection and to funnel spilled ingredient away from the ledge,
a tray mounted under the ledge to contain the leaked and spilled ingredient, wherein the tray can be extracted with the assistance of a handhold to perform ingredient disposal, and
a liquid detection sensor, positioned below the spout's nozzle and electrically coupled to the spout controller to enable interrupt handling upon each occurrence when a leaked beverage ingredient is detected; and
a rack controller to manage and process the performances of Protocol-directed beverage dispensing activities.

6. The beverage dispensing activities system of claim 5, wherein the rack controller comprises:
a processor, electrically coupled to the spout controllers and configured to programmatically execute the requirements of messaging protocol packets and handle sensor interrupts;
a RF transceiver, electrically coupled to the processor and configured to programmatically communicate and process messaging protocol packets;
a locking mechanism, electrically coupled to the processor and configured to secure the rack to the housing, wherein the rack is releasable when the locking mechanism is energized;
a lock sensor electrically coupled to the processor to enable interrupt handling upon each occurrence when the rack is released and extracted from the housing or inserted to the housing and secured; and
a power disruption sensor electrically coupled to the processor to enable interrupt handling upon each occurrence when the backup power has replaced the main power.

7. The beverage dispensing activities system of claim 1, wherein the parameter comprises:
a plurality of variable-length character strings; and
a plurality of delimiters defined with a hierarchal order to partition the parameters.

8. The beverage dispensing activities system of claim 7, wherein the parameter further comprises:
alphabetic characters;
numeric characters;
non-alphanumeric characters;
alphabetic and numeric characters;
alphabetic and non-alphanumeric characters;
numeric and non-alphanumeric characters; or
alphabetic, numeric, and non-alphanumeric characters.

9. The beverage dispensing activities system of claim 8, wherein the parameter yet further comprises:
a plurality of encoded ‘ready’ requirements and results;
a plurality of encoded ‘release’ requirements and results;
a plurality of encoded ‘replace’ requirements and results;
a plurality of encoded ‘cancel’ requirements and results;
a plurality of encoded ‘pour’ requirements and results;
a plurality of encoded ‘self-test’ requirements and results;
a plurality of encoded rack management activities requirements and results;
a plurality of encoded beverage management activities requirements and results;
a plurality of encoded inventory management activities requirements and results;
a plurality of encoded audit management activities requirements and results; and
a plurality of encoded abnormal activities events, requirements, and results.

10. The beverage dispensing activities system of claim 1, wherein the server network comprises:
a plurality of clients, wherein each client is a subscriber to initiate messaging protocol packets, receive messaging protocol packets, or initiate and receive messaging protocol packets;
a wireless network to communicate messaging protocol packets over a local area network between connected clients by radio frequency (RF) and Wi-Fi means; and
a client-server configured to programmatically execute the methods of a messaging protocol to manage the distributions of messaging protocol packets over the wireless network.

11. The beverage dispensing activities system of claim 10, wherein the client-server can receive subscriptions from radio frequency (RF) transceivers, point of sale systems, computing devices, messaging controllers, rack controllers, spout controllers, and Wi-Fi clouds to be clients.

12. The beverage dispensing activities system of claim 11, wherein the messaging controller comprises:
a processor configured to programmatically execute the pre-processing requirements, post-processing results, database management, and distributions of the communicated messaging protocol packets;
a RF transceiver, electrically coupled to the processor and configured to programmatically communicate and process messaging protocol packets; and
a storage medium, electrically coupled to the processor and configured to maintain a real-time accessible beverage dispensing and inventory database.

13. The ingredient dispensing system of claim 2, wherein the pourer comprises:
a beverage plug with a hollow cylindrical stopper and a top flange, wherein the stopper when inserted into a beverage opening will seal the beverage opening and establish a conduit for the passage of ingredient from the beverage;
a tap, coupled to the beverage plug and configured with fasteners to secure the top flange against the beverage opening;
a spout, when coupled to the tap will establish a conduit for the passage of ingredient from the beverage plug; and
food-safe acrylic, crystalline, metallic, and plastic materials.

14. The ingredient dispensing system of claim 13, wherein the stopper is compressible and will expand laterally when compressed.

15. The ingredient dispensing system of claim 13, wherein the tap comprises:
a hollow cylindrical stem with a base flange, configured with a breather hole on the surface of the stem wherein the breather hole is unobstructed after the beverage plug has sealed the beverage opening;
a breather air tube, coupled to the interior wall of the stem and configured with the front section of the breather air tube coupled to the breather hole and with the tail section of the breather air tube exiting through the base flange;
a first check valve with a bent tail-tube is coupled to the tail section of the breather air tube and a second check valve is coupled to the bent tail-tube,
wherein air is permitted to enter through the breather hole and into the beverage during ingredient dispensing;
wherein beverage ingredient is prevented from entering into the breather air tube through the first check valve and bent tail tube during mounted beverage inactivity; and
wherein beverage ingredient is prevented from entering into the breather air tube through the second check valve when the tap and beverage plug is begin inserted into a beverage opening.

16. The ingredient dispensing system of claim 13, wherein the spout comprises:
a first diameter opening to couple with the stem of the tap to establish a conduit for the passage of ingredient from the beverage plug into a stem chamber and a second diameter opening located at the opposite end of the first diameter opening to enable the insertion of a gear shaft into a shaft chamber to couple to a shaft joint that is center mounted to a cylindrical disk that is positioned between the shaft and stem chamber,
wherein the ingredient in the stem chamber will activate a liquid level indicator;
wherein the cylindrical disk is pressed against an O-ringed affixed to the stem chamber's opening;
wherein the ingredient held in the stem chamber and monitored by the liquid level indicator is allowed passage into an inner chamber when the shaft joint is affected by the gear shaft to position the opening on the cylindrical disk into alignment with the stem chamber's opening;
a wedge coupled to the top-surface above the exterior-opening of the stem chamber, wherein when coupled to a top channel on the spout controller will immobilize the spout and activate a switch sensor; and
a nozzle coupled to the bottom-surface below the exterior-opening of the shaft chamber to direct the passage of ingredient from the inner chamber into a container placed on the ledge.

17. The ingredient dispensing system of claim 2, wherein the spout controller comprises:
a processor configured to programmatically execute sensor interrupt handlings and control the performances of Protocol-directed beverage dispensing activities and, in particular, the activity of ingredient dispensing;
a RF transceiver, electrically coupled to the processor and configured to programmatically communicate and process messaging protocol packets;
a bottom channel to accept the insertion of the nozzle to orient and direct the insertion of the spout into the cored opening to encapsulate the spout and to align the shaft chamber to couple the shaft joint with a gear shaft, and a top channel to accept the coupling of the wedge,
wherein the wedge activates the switch sensor electrically coupled to the processor to enable interrupt handling upon each occurrence when the wedge is coupled to or decoupled from the top channel;
wherein the switch sensor activates a plurality of illuminations electrically coupled to the processor and configured with colored displays, visible on the surface of the faceplate near the dispensing-opening, to coordinate the performances of beverage dispensing activities;
wherein the switch sensor further activates a liquid level sensor electrically coupled to the processor and optically aligned with the liquid level indicator through a port hole on the spout, after the encapsulation of the spout, to enable interrupt handling upon each occurrence when an empty beverage condition triggers the liquid level indicator to notify the liquid level sensor;
an electromagnetic device, electrically coupled to the processor to enable the distribution of a controlled force to affect the opening on the cylindrical disk to control the passage of ingredient into the inner chamber; and
a vibration motor, positioned against the nozzle after the coupling of the spout to the spout controller and electrically coupled to the processor to enable the generation of a momentary agitation toward the end of ingredient passage to dislodge any remainder of ingredient clinging to the inner chamber and the nozzle, to fall into a container.

18. A method for performing beverage dispensing activities, comprising the steps of:
a dispensing activity such as a drink order is composed into requirements in the form of encoded parameters, bundled within a messaging protocol packet, initiated from a client, communicated to the client-server, and distributed to a messaging controller over a wireless network;
the messaging controller receives the messaging protocol packet, extracts the requirements from the messaging protocol packet, save the original requirements to storage, confirms the requirements are valid, verifies the requirements are performable, separate the requirements into discrete activity parameters when necessary, composes each discrete activity parameter into a proper requirement, records the requirements, bundle each requirement into a messaging protocol packet, and initiates the messaging protocol packets to the client-server for distribution to the rack controllers, spout controllers, and clients that have subscribed to receive each of the requirements,
wherein a rack controller programmatically receives the messaging protocol packet, extracts the requirement from the messaging protocol packet, records the requirement, performs the requirement to completion, updates the results from the performance to the requirement, bundles the updated requirement into a messaging protocol packet, and initiates the messaging protocol packet to the client-server for distribution to the messaging controller and clients that have subscribed to receive the results;
wherein a spout controller programmatically receives the messaging protocol packet, extracts the requirement from the messaging protocol packet, records the requirement, performs the requirement to completion, updates the results from the performance to the requirement, bundles the updated requirement into a messaging protocol packet, and initiates the messaging protocol packet to the client-server for distribution to the messaging controller and clients that have subscribed to receive the results;
wherein one or more clients programmatically receive the messaging protocol packet, extract the requirement from the messaging protocol packet, and perform the requirement to completion, and if necessary: update the results from the performance to the requirement, bundle the updated requirement into a messaging protocol packet, and initiate the messaging protocol packet to the client-server for distribution to other clients that have subscribed to receive the results;
the messaging controller receives the messaging protocol packets, extracts the requirement from the messaging protocol packet, updates the results from the requirement to the dispensing and beverage inventory database, update the results to the original requirements, bundles the updated original requirements into a messaging protocol packet, and initiates the messaging protocol packet to the client-server for distribution to clients that have subscribed to receive the results; and
wherein during dispensing activities performances, sensors detecting abnormal activities that was purposefully directed or has naturally occurred at the housing, will enable interrupt handling by the connected processor to programmatically log the abnormal activities, attempt reconciliation, compose an event of the abnormal activity updated with results from the reconciliation, bundle the updated event into a messaging protocol packet, and initiate the messaging protocol packet to the client-server for distribution to clients that have subscribed to receive the events.

19. The method for performing beverage dispensing activities of claim 18 and, in particular, the activity of dispensing a drink order ingredient, comprising the steps of:
the spout controller begins performing the requirement by retrieving stored beverage data to determine whether there is sufficient ingredient in the mounted beverage to perform the required dispensing, storing beverage data in anticipation of a possible empty beverage condition, applying the requirement and retrieved data to calculate the pour-time necessary for the electromagnetic device to affect the opening on the cylindrical disk to transition from the ‘closed’ to the ‘open’ and back to the ‘closed’ position relative to the stem chamber opening to dispense the required amount of the beverage ingredient,
wherein the calculation includes factoring the viscosity type of the ingredient, with the flow rate of the ingredient through the stem chamber opening induced by gravity as the opening on the cylindrical disk is transitioning between ‘closed’ to the ‘open’ and back to the ‘closed’ position relative to the stem chamber opening, and the latency of the electromagnetic device to execute the transition to affect the dispensing of the required amount of the ingredient;
the spout controller begins energizing the illuminations on the surface of the faceplate to direct the user to the designated dispensing-opening to insert a container;
the object detection sensor begins monitoring the ledge for container placement and removal,
wherein upon receiving an interrupt from the object detection sensor indicating a container is properly placed on the ledge, the spout controller initiates the count-up timer to begin counting toward the pour-time and energizes the electromagnetic device to begin the controlled transition of the cylindrical disk into the ‘open’ position to initiate ingredient passage into the inner chamber;
wherein upon completing the count-up to the calculated pour-time the opening on the cylindrical disk has transitioned to the ‘closed’ position, ingredient passage into the inner chamber has stopped, the vibration motor is energized briefly to dislodge any remainder of ingredient still clinging to the inner chamber and nozzle, power to the electromagnetic device is terminated, the illuminations are updated to notify the user that ingredient dispensing has completed, and the container is ready for retrieval;
wherein upon receiving an interrupt from the object detection sensor indicating the container has been removed off the ledge, the spout controller terminates power to the illuminations and the object detection sensor, updates beverage data, and reconciles the successful, partial, or failed performance results for distribution; and
the spout controller determines whether the activity of dispensing another drink order ingredient is required and if necessary proceeds to repeat the steps of dispensing a drink order ingredient.
